(19) United States
(12) Patent Application Publication
(10) Pub. No.: US 2003/0101378 A1
(43) Pub. Date: May 29, 2003

(54) ID generation device and Id verification device

(76) Inventor: Kenichi Ohkubo, Katano-shi (JP)

Correspondence Address: SHERIDAN ROSS PC, 1560 BROADWAY, SUITE 1200, DENVER, CO, 80202

(21) Appl. No.: 10/306,941

(22) Filed: Nov. 27, 2002

(30) Foreign Application Priority Data
Nov. 27, 2001 (JP) 2001-360442

(51) Int. Cl. H02H 3/05

(52) U.S. Cl. 714/37

(57) ABSTRACT

An ID generating device and an ID verification device for improving the security of an ID code. The ID verification device, which is arranged in a device body, includes a code generation device for generating a random code string. A predetermined operation is performed on the random code string to generate a first ID code. The ID generation device is arranged in an accessory of a device body and electrically connected to the ID generation device, which receives the random code string and performs a predetermined operation on the random code string to generate a second ID code. The ID verification device receives the second ID code from the ID generation device, compares the first and second ID codes, and judges whether the accessory is valid in accordance with the comparison result.

### BACKGROUND OF THE INVENTION

The present invention relates to an identification (ID) generation device and an ID verification device used to verify valid devices.

Devices, such as a cellular phone and a portable information terminal, normally has a battery pack, which supplies the device with power and which is detachable from the device. When the battery pack deteriorates, the battery pack is replaced by a fresh battery pack. This enables continuous use of the device.

However, there are battery packs that are manufactured without permission (hereinafter, referred to as invalid battery packs). Compared to valid battery packs, the quality of invalid battery packs tends to be low since they must be manufactured under lower costs. As a result, the employment of an invalid battery pack may damage the device.

Accordingly, in the prior art, and identification signal (ID code) is used to identify valid battery packs and invalid battery packs. More specifically, a battery pack and the device to which it is attached each store an ID code. When the battery pack is attached to the device, the ID code output from the battery pack is compared with the ID code stored in the device to verify the battery pack. This identifies invalid battery packs that do not have the ID code.

However, in the prior art verifying technique, the ID code may be obtained in a relatively simple manner by, for example, detecting the contents of data communicated between the battery pack and the device. This creates a problem with regard to the security of the ID code.

### SUMMARY OF THE INVENTION

It is an object of the present invention to provide an ID generating apparatus and an ID verification device that improves the security of an ID code.

To achieve the above object, the present invention provides an ID generation device for generating an ID code indicating the type of a device in response to an input signal including a predetermined code string. The ID generation device includes an ID generation circuit for generating the ID code by performing a predetermined operation with the input signal. An input/output switching circuit is connected to the ID generation circuit for receiving the input signal from an external device and returning the ID code to the external device. A detection circuit is connected to the input/output switching circuit for detecting the predetermined code string. The input/output circuit outputs the ID code in response to the detection result of the detection circuit.

A further perspective of the present invention is a system for verifying whether an accessory attached to a device body is valid. The system includes an ID verification device arranged in the device body. The ID verification device includes a code generation circuit for generating a random code string. A first ID generation circuit is connected to the code generation circuit for generating a first ID code by performing a predetermined operation with the random code string. An ID generation device arranged in the accessory and electrically connected to the ID verification device when the accessory is attached to the device body. The ID generation device includes a second ID generation circuit for receiving the random code string and generating a second ID code by performing a predetermined operation with the random code string. The ID verification device receives the second ID code from the ID generation device, compares the first ID code with the second ID code, and judges whether the accessory is valid in accordance with the comparison result.

A further perspective of the present invention is a method for verifying the validity of an accessory attached to a device body. The method includes generating a random code string in the device body, generating a first ID code in the device body by performing a predetermined operation with the random code string, transferring the random code string to the accessory, generating a second ID code in the accessory by performing a predetermined operation with the random code string, transferring the second ID code to the device body, comparing the first ID code and the second ID code, and judging whether the accessory is valid in accordance with the comparison result.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of an ID generation device and an ID verification device according to a first embodiment of the present invention;

FIG. 2 is a flowchart illustrating a verification procedure performed by the ID generation device and ID verification device of FIG. 1;

FIG. 3 is a schematic block diagram of an ID generation circuit and a key data register of the ID generation device of FIG. 1;

FIG. 4 is a time chart illustrating data communication between the ID generation device and the ID verification device of FIG. 1;

FIG. 5 is a schematic block diagram of a battery pack including an ID generation device according to a second embodiment of the present invention;

FIG. 6 is a schematic circuit diagram illustrating the flow of a clock signal and the detection of data output from a thermistor;

FIG. 7 is a schematic block diagram of a battery pack in a modification of the second embodiment; and

FIGS. 8A and 8B are time charts illustrating data communication between an ID generation device and an ID verification device in modifications of the other embodiments.

### DETAILED DESCRIPTION OF THE PREFERRED EMBODIMENTS

In the drawings, like numerals are used for like elements throughout.

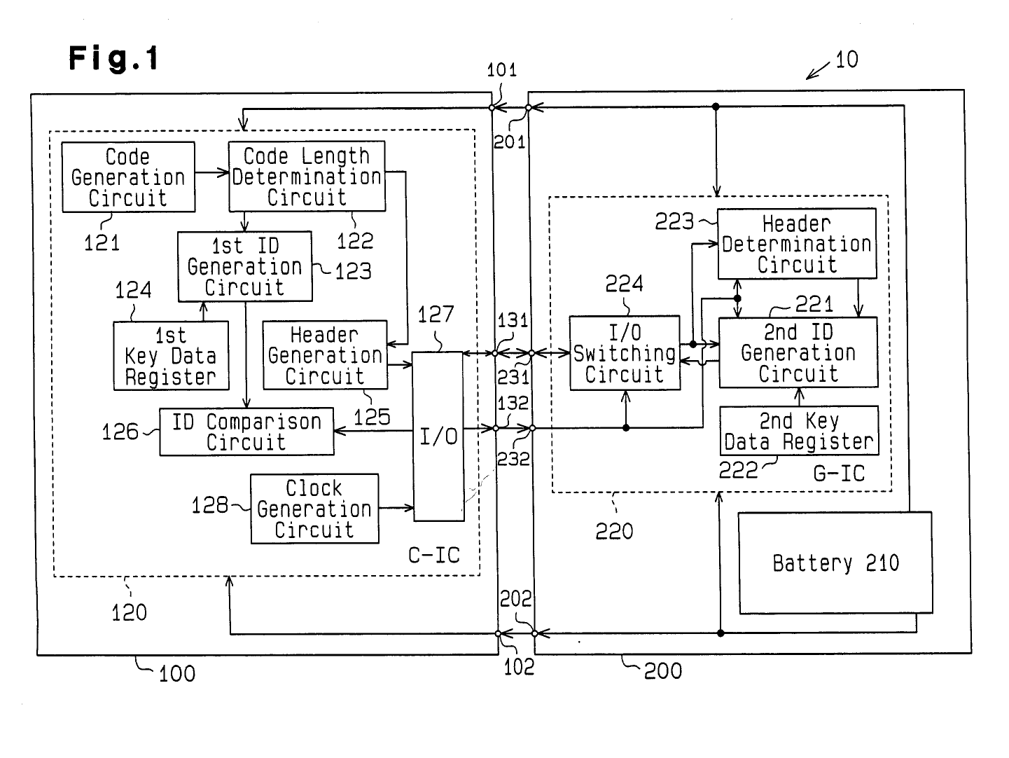

FIG. 1 is a schematic block diagram showing a cellular phone 10. The cellular phone 10 includes an ID generation device and an ID verification device according to a first embodiment of the present invention.

The cellular phone 10 includes a phone body 100 and a battery pack (accessory) 200. The battery pack 200 is detachable from the body 100.

The body 100 includes an ID verification integrated circuit (IC). The battery pack 200 includes a battery 210 and an ID generation IC (G-IC) 220. The ID generation IC is used exclusively for generating an ID.

The body 100 includes power receiving terminals 101, 102, and the battery pack 200 includes power supplying terminals 201, 202. The power receiving terminals 101, 102 are electrically connected to the power supplying terminals 201, 202. This supplies the phone body 199 with power from the battery pack 200.

Further, the body 100 includes an input/output terminal (first input/output terminal) 131 and a clock output terminal 132. The battery pack 200 includes an input/output terminal (second input/output terminal) 231 and a clock input terminal 232. The ID verification IC 120 provides the ID generation IC 220 with a clock signal via the clock output terminal 132 and the clock input terminal 232. Data is communicated between the ID verification IC 120 and the ID generation IC 220 via the input/output terminals 131, 231 to verify whether the battery pack 200 is a valid one.

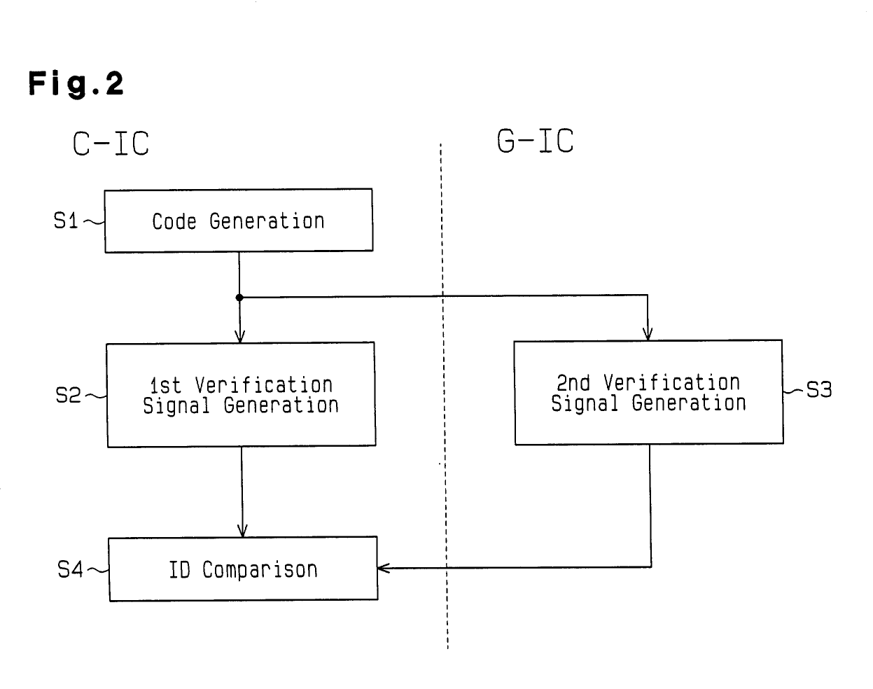

FIG. 2 illustrates the basic procedures of the verification process.

The ID verification IC 120 first generates a random code (code string) to verify whether the battery pack 200 is a valid one (step S1). Then, the ID verification IC 120 performs a predetermined operation with the random code to generate a first verification signal (ID code) (step S2).

The ID generation IC 220 performs a predetermined operation with the random code to generate a second verification signal (ID code) (step S3). The operation of step S3 is performed in the same manner as that of step S2. The ID verification IC 120 receives the second verification signal from the ID generation IC and compares the first and second verification signals to judge whether the battery pack 200 is a valid one (step S4).

By performing the same operation in the body 100 and the battery pack 200 with the random code to generate the verification signal, accurate verification is performed while security is guaranteed. In the first embodiment, random data is communicated between the body 100 and the battery pack 200. Thus, even if the contents of data communication between the body 100 and the battery pack 200 is monitored, the verification of the battery pack 200 with the body 100 is difficult to recognize.

The ID verification IC 120 of the phone body 100 and the ID verification IC of the battery pack 200 will now be discussed with reference to FIG. 2.

The ID verification IC 120 includes a code generation circuit 121, a code length determination circuit 122, a first ID generation circuit 123, and a first key data register 124. The code generation circuit 121 generates random data having a predetermined data length. The code generation circuit 121 includes, for example, a random number generator or a random number sequence to generate random data in accordance with the random number generator or the random number sequence.

From the random data, the code length determination circuit 122 determines the bit number of the data (code string) used to generate the first identification signal. The bit number is less than or equal to the length of the random data, which is one or greater and generated by the code generation circuit 121 using the random number generator or the random number sequence. When the code length determination circuit 122 designates a data length of, for example, “five bits”, five bits of random data are used to generate the first identification signal (ID code).

The first ID generation circuit performs a predetermined operation with a random code string to generate the first ID code. More specifically, the operation of the first ID generation circuit 123 is performed using the first key data register 124 in addition to the random code string.

The ID verification IC 120 further includes a header generation circuit 125, an ID comparison circuit 126, an input/output circuit 127, and a clock signal generation circuit 128. Prior to the transfer of the predetermined random code string to the battery pack 200, the header generation circuit 125 generates a header signal notifying such transfer. The ID comparison circuit 126 compares the first ID code and a second ID code, which is transferred from the battery pack 200, and judges that the battery pack 200 is a valid battery pack when the first and second ID codes match each other. The clock signal generation circuit 128 generates a clock signal. The random code string or header signal is transferred to the ID generation IC 220 via the input/output circuit 127 in accordance with the clock signal.

The ID generation IC 220 further includes an input/output switching circuit (I/O switching circuit) 224, which performs bidirectional communication, via a serial line connecting the input/output terminals 131, 231. The I/O switching circuit 224 provides the second ID generation circuit with the random code string to which the header is added, and returns the second ID code to the phone body (external device) 100.

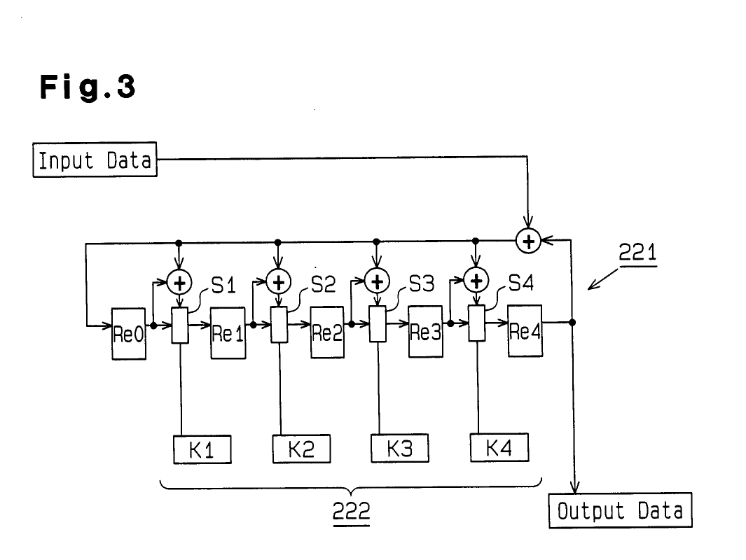

The first and second ID generation circuits 123, 221 and the first and second key data registers 124, 222 will now be discussed in detail. The first and second ID generation circuits 123, 221 have substantially the same configuration. Thus, only the second ID generation circuit 221 will be described. FIG. 3 is a schematic block diagram of the second ID generation circuit 221 and the second key data register 222.

As shown in FIG. 3, the second ID generation circuit 221 includes series-connected registers Re0 to Re3, which latch input data, and selectors SE1 to SE4, which respectively retrieve the output of the registers Re0 to Re3. The selector SE1 is connected between the registers Re0, Re1, and the selector SE2 is connected between the registers Re1, Re2. The selector SE3 is connected between the registers Re2, Re3, and the selector SE4 is connected between the registers Re3, Re4.

The output data of the selector SE4 is latched by the register Re4. The output data of the register Re4 is the output data of the second ID generation circuit 221. The exclusive OR of the input data and the output data of the second ID generation circuit (in FIG. 3, + denotes an exclusive OR gate) and the exclusive OR of the output of each register Re0 to Re3 are input to the associated selectors SE1 to SE4.

The second key data register 222 includes non-volatile registers K1 to K4. The registers K1 to K4 hold and provide one bit of data to the selectors SE1 to SE4. When each of the selectors SE1 to SE4 receive a signal having a high level from the corresponding register K1 to K4, the value of the exclusive OR is provided to the register in the subsequent stage. When each of the selectors SE1 to SE4 receive a signal having a low level from the corresponding register K1 to K4, the value of the exclusive OR in the register of the prior stage is provided to the register in the subsequent stage. The registers K1 to K4 may be, for example, a ROM or a switch, which is fixed in an ON state or an OFF state. The drive of each selector SE1 to SE4 is set by the second key data register 222. This improves security of the operation for generating the ID code.

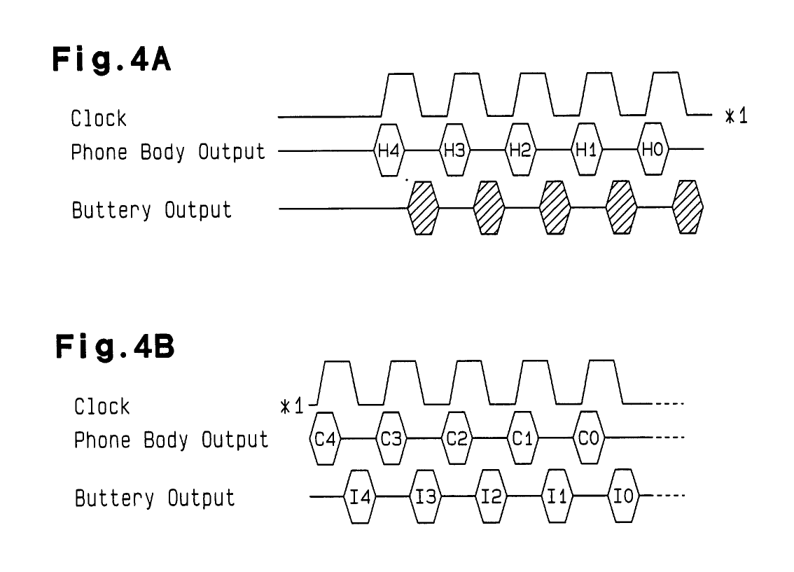

The bidirectional data communication performed via a serial line connecting the input/output terminals 131, 231 will now be discussed with reference to FIG. 4.

In the first embodiment, bidirectional data communication is performed in synchronism with the rising edge and trailing edge of the clock signal. More specifically, data is transferred from the phone body 100 to the battery pack 200 in synchronism with the rising edge of the clock signal and from the battery pack 200 to the phone body 100 in synchronism with the trailing edge of the clock signal. Data communication is performed, for example, using the open drain technique.

Referring to FIG. 4A, when a header signal (H4, H3, . . . ) is transferred from the phone body 100 to the battery pack 200 in synchronism with the rising edge of the clock signal, a non-ID code is output from the battery pack 200. As shown in FIG. 3, the second ID generation circuit 221 generates the non-ID code in accordance with the header signals and the signals latched by the registers Re0 to Re4.

When all of the header signals are transferred to the battery pack 200, the header determination circuit (detection circuit) 223 determines the receipt of the header signal and initializes the second ID generation circuit 221. In this state, all of the signals latched by the registers Re0 to Re4 are initialized to, for example, “0”.

Subsequent to the initialization, as shown in FIG. 4B, when a random code string (C4, C3, . . . ) is transferred from the body 100 to the battery pack 200, the ID generation IC 220 generates a second ID code (I4, I3, . . . ) in accordance with the code string and transmits the second ID code to the body 100. That is, whenever each bit of the random code is output from the body 100 in synchronism with the rising edge of the clock signal, the bit data of the second ID code corresponding to each bit of the code string is transmitted to the body 100 from the battery pack 200 in synchronism with the trailing edge of the clock signal.

When the code string (C4, C3, . . . ) transferred to the battery pack 200 is determined, the first ID generation circuit 123 of the body 100 is initialized, for example, in accordance with an initialization signal provided from the code length determination circuit 122. Thus, the first ID code, which is generated in accordance with the random code string (C4, C3, . . . ) is substantially the same as the second ID code, which is generated in the second ID generation circuit 221.

The ID comparison circuit 126 compares the second ID code transferred from the battery pack 200 with the second ID code generated by the first ID generation circuit 123 to judge whether the battery pack 200 is a valid one in accordance with the comparison result.

The first ID generation circuit 123 may be initialized in synchronism with the initialization of the second ID generation circuit 221. Further, the generation of an ID code in the first ID generation circuit 123 and in the second ID generation circuit 221 may be synchronized. In this case, the comparison of the first and second ID codes is performed one bit at a time in synchronism with the clock signal.

The ID verification IC (ID verification device) 120 and the ID generation IC (ID generation device) 220 have the advantages described below.

(1) The ID verification IC 120 and the ID generation IC 220 generate the first and second verification signals (ID codes) by performing a predetermined operation on the random code, which is generated by the ID verification IC 120. Thus, random data is transferred between the body 100 and the battery pack 200 to perform verification with high security.

(2) The first and second ID generation circuits 123, 221 each perform a predetermined operation with the first and second key data registers 124, 222 in addition to the random code string. Thus, the first and second key data registers 124, 222, which are necessary to generate the valid ID code from the random code string, further increases security.

(3) The code length determination circuit 122 changes the data length of the code string used to generate the ID code at random. This further increases security when performing verification.

(4) The first and second ID generation circuits 123, 221 are initialized prior to the input of the code string, which generates the ID code. Thus, the initialization conditions for the generation of the first ID code are the same as those for the generation of the second ID code. Thus, ID codes, which are identical to each other, are generated.

(5) The transfer of each piece of bit data from the ID verification IC 120 to the ID generation IC 220 is performed in synchronism with the rising edge of the clock signal. The transfer of each piece of bit data from the ID generation IC 220 to the ID verification IC 120 is performed in synchronism with the trailing edge of the clock signal. Thus, data communication is readily performed. Further, analysis of data communicated between the body 100 and the battery pack 200 to obtain the ID code becomes further difficult. As a result, security is further increased when performing verification.

An ID generation device 220A and an ID verification device 120A according to a second embodiment of the present invention will now be discussed.

The temperature of a battery pack in a cellular phone increases when charging the battery. Thus, the phone body monitors the temperature of the battery pack so that temperature of the battery pack does not exceed a predetermined value. When the battery is charged by supplying the battery with power from a power supply, which is connected to the phone body, the phone body monitors data output from a temperature detection sensor, which is installed in the battery pack. Charging is suspended when the monitored temperature exceeds a predetermined temperature.

However, additional terminals and signal wires are necessary to retrieve the data of the temperature detection sensor. This increases the number of parts and the size of the cellular phone. Accordingly, in the second embodiment, the data of the temperature detection sensor that is transmitted to the phone body shares the same signal line as the clock signal. In other words, the clock signal is provided to the battery pack only when verifying whether the battery pack is a valid one. Thus, the signal wire for transmitting the data of the temperature detection sensor is the same as the signal wire for providing the battery pack to the clock signal.

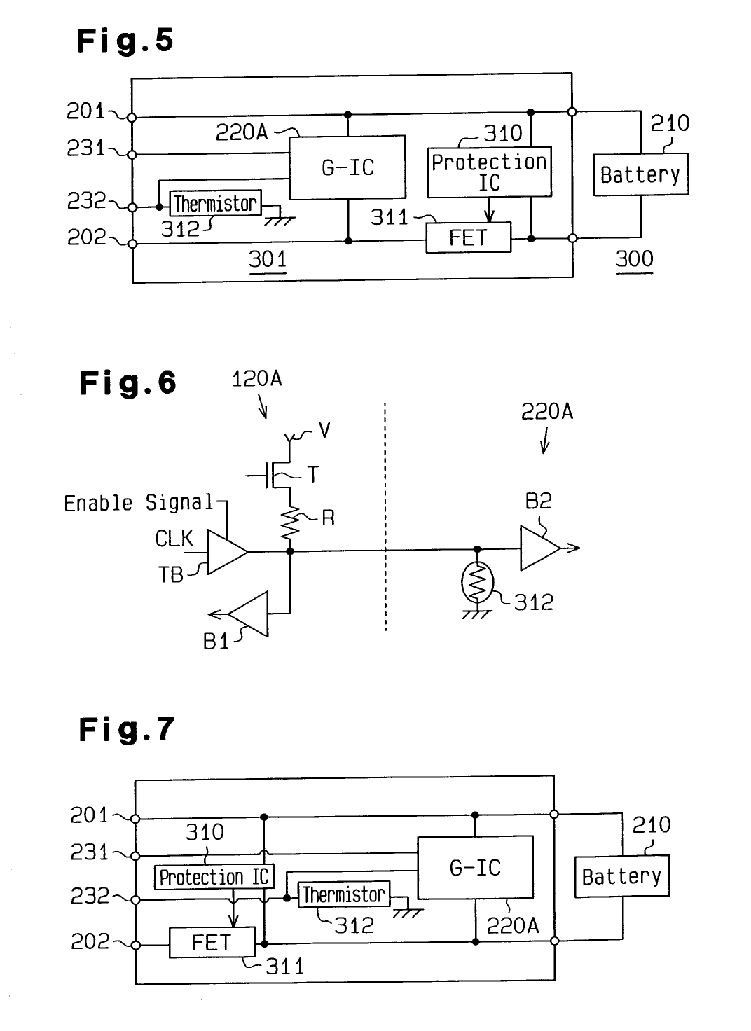

FIG. 5 is a schematic block diagram of a battery pack 300, which includes a temperature detection sensor and the ID generation device 120A of the second embodiment. As shown in FIG. 5, the battery pack 300 includes an ID generation IC 220A and a battery 210.

The ID generation IC 220A is formed on a substrate 301. The battery 210 is attached to the substrate 301. A protection IC 310 and a switching transistor (FET) 311 are arranged on the substrate 301 to cut the supply of power from the battery 210 to the phone body 100 and the ID generation IC 220A when the battery 210 is abnormal. The protection IC 310 deactivates the FET 311 when the battery 210 is abnormal to stop the supply of power to the phone body 100 and the ID generation IC 220A.

The battery pack 300 includes a thermistor (temperature detection sensor) 312, the resistance of which varies in accordance with the temperature. The thermistor 312 and the ID generation IC 220A are connected to the clock input terminal 232.

FIG. 6 illustrates a circuit for retrieving data of the thermistor 312 and a circuit for providing a clock signal CLK to the battery pack 300, which are arranged in, for example, the ID verification device 120A of the phone body 100. The ID verification device 120A includes a tri-state buffer TB, which receives the clock signal CLK. The output terminal of the tri-state buffer TB is connected to a clock buffer B2, which is arranged in the ID generation IC 220. The thermistor 312 is connected between the tri-state buffer TB and the clock buffer B2. To detect the temperature of the thermistor 312, the ID verification device 120A includes a resistor R and a buffer B1, which are connected in series to a power supply V via a transistor T. The thermistor 312 is connected between the resistor R and the buffer B1.

When the thermistor 312 detects the temperature, an enable signal sets the output terminal of the tri-state buffer TB to a high impedance state, and the transistor T is activated. Thus, the resistor R and the thermistor 312 are supplied with power V. The resistance of the thermistor 312 and the resistor R generates a divisional voltage of the power V, which is varied in accordance with the resistance of the thermistor 312. Thus, the temperature of the battery pack 300 is detected from the divisional voltage of the power V.

When the battery pack 300 is provided with the clock signal CLK, the transistor is deactivated, and the tri-state buffer TB is provided with the enable signal. The tri-state buffer TB provides the clock buffer B2 with the clock signal CLK in accordance with the enable signal.

The transistor T, the tri-state buffer TB, and the buffer B1 are arranged in, for example, the input/output circuit 127 of FIG. 1.

In addition to the advantage of the first embodiment, the ID verification device 120A and the ID generation device 220A of the second embodiment has the advantage described below.

The output data of the thermistor 312 that is transferred to the phone body 100 shares the same line as that through which the clock signal CLK is provided. This reduces the number of parts. As a result, the battery pack 300 may be made more compact 300.

In the second embodiment, the random code string and the ID code may share the same signal line with the output data of the temperature detection sensor.

In the second embodiment, data for monitoring a state of the battery pack other than the temperature may be transferred through the signal line used to transfer the random code string and the ID code or the signal line used to provide the clock signal. The monitored data includes, for example, data related to the battery capacity. That is, after the battery is charged, the output current of the battery may be detected and integrated to calculate the battery capacity.

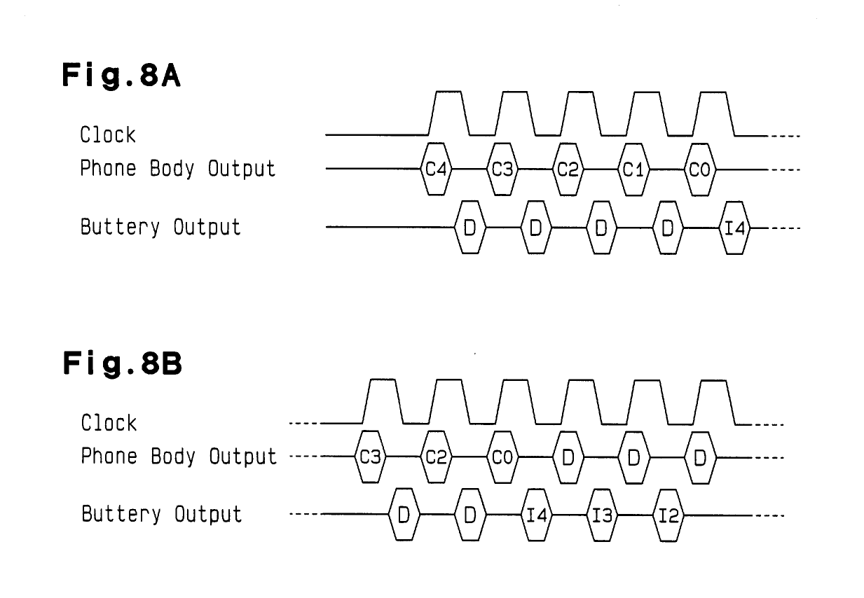

In each of the above embodiments, referring to FIG. 8A, an ID code may be provided from a battery pack to the phone body after all of the code string data is provided to the battery pack. In this case, when the code string is input to the battery pack, the battery pack (ID generation IC) may transfer a dummy signal (denoted by D in FIG. 8A) when the code string is input to the battery pack. The dummy signal may be generated by, for example, holding the data used in the previous verification process and using the held data. The dummy signal may also be generated by using the random number sequence. The dummy signal does not necessarily have to be transmitted in correspondence with the data of the first bit of the code string and may be transmitted after a predetermined bit of the code string is input.

Referring to FIG. 8B, when the ID code is output from the battery pack to the phone body and a signal is not provided to the battery pack from the main body, a dummy signal may be output from the main body to the battery pack.

In FIGS. 8A and 8B, at least one bit of data is transferred within a single cycle of the clock signal in each of the following bidirectional data transfers (A and B).

(A) Transfer of data, which includes a code string, from the phone body (ID verification device) to the battery pack (ID generation device).

(B) Transfer of data, which includes an ID code based on the code string, from the battery pack to the phone body.

In each of the above embodiments, the functions of the ID verification IC and the ID generation IC may be performed by software. For example, some or all of the functions of the ID verification IC may be realized by a operation program executed by a CPU (not shown) of the ID verification IC.

The present invention is applied when using a verification signal to verify valid devices. For example, the present invention is applied when verifying an ink cartridge that is set in a printer or a memory card that is set in an electronic calculator.

The present examples and embodiments are to be considered as illustrative and not restrictive, and the invention is not to be limited to the details given herein, but may be modified within the scope and equivalence of the appended claims.

What is claimed is:

1. An ID generation device for generating an ID code indicating the type of a device in response to an input signal including a predetermined code string, the ID generation device comprising:
an ID generation circuit for generating the ID code by performing a predetermined operation with the input signal;
an input/output switching circuit connected to the ID generation circuit for receiving the input signal from an external device and returning the ID code to the external device; and
a detection circuit connected to the input/output switching circuit for detecting the predetermined code string;
wherein the input/output circuit outputs the ID code in response to the detection result of the detection circuit.

2. The ID generation device according to claim 1, further comprising a register connected to the ID generation circuit for holding data used in the predetermined operation of the ID generation circuit.

3. The ID generation device according to claim 1, further comprising:
a clock input terminal connected to the ID generation circuit and the detection circuit, wherein the clock input terminal is provided with a clock signal synchronized with the input signal; and
an input/output terminal connected to the input/output switching circuit, wherein the input/output terminal is provided with the input signal and used to output the ID code;
wherein the input/output switching circuit inputs at least one bit of the input signal and outputs at least one bit of the ID code in a single cycle of the clock signal.

4. The ID generation device according to claim 3, wherein the ID generation circuit generates a dummy code prior to the generation of the ID code.

5. An ID verification device for providing a predetermined signal to an external device and verifying the validity of an ID code provided from the external device in response to the predetermined signal, the ID verification device comprising:
a code generation circuit for generating a random code string;
an ID generation circuit connected to the code generation circuit for generating a first ID code by performing a predetermined operation with the random code string;
a header generation circuit connected to the code generation circuit for adding a header to the random code string;
an input/output circuit connected to the header generation circuit for providing the external device with the random code string to which the header is added and for retrieving a second ID code provided from the external device in response to the header; and
a comparison circuit connected to the ID generation circuit and the input/output circuit for comparing the first ID code with the second ID code;
wherein the comparison circuit judges the validity of the second ID code in accordance with the comparison result.

6. The ID verification device according to claim 5, further comprising:
a register connected to the ID generation circuit for holding data used in the predetermined operation of the ID generation circuit.

7. A system for verifying whether an accessory attached to a device body is valid, the system comprising:
an ID verification device arranged in the device body, wherein the ID verification device includes;
a code generation circuit for generating a random code string;
a first ID generation circuit connected to the code generation circuit for generating a first ID code by performing a predetermined operation with the random code string;
an ID generation device arranged in the accessory and electrically connected to the ID verification device when the accessory is attached to the device body, wherein the ID generation device includes;
a second ID generation circuit for receiving the random code string and generating a second ID code by performing a predetermined operation with the random code string;
wherein the ID verification device receives the second ID code from the ID generation device, compares the first ID code with the second ID code, and judges whether the accessory is valid in accordance with the comparison result.

8. The system according to claim 7, wherein the ID verification device includes a first register connected to the first ID generation circuit for holding data used in the predetermined operation of the first ID generation circuit, and wherein the ID generation device includes a second register connected to the second ID generation circuit for holding data used in the predetermined operation of the second ID generation circuit.

9. The system according to claim 7, wherein the ID verification device includes:
a header generation circuit connected to the code generation circuit for adding a header to the random code string;
wherein the ID generation device includes:
an input/output switching circuit connected to the second ID generation circuit for providing the second ID generation circuit with the random code string to which the header is added; and
a detection circuit connected to the input/output switching circuit and the second ID generation circuit for detecting the header;
wherein the input/output switching circuit provides the ID verification device with the second ID code in response to the detection of the header by the detection device.

10. The system according to claim 7, wherein the ID verification device includes a clock signal generation circuit for generating a clock signal and providing the ID generation device with the clock signal, and wherein the ID generation device receives at least a one bit code of the random code string from the ID verification device and provides the ID verification device with at least a one bit code of the second ID code in a single cycle of the clock signal.

11. The system according to claim 7, wherein the second ID generation circuit generates a dummy code prior to the generation of the second ID code and provides the ID verification device with the dummy code.

12. The system according to claim 7, wherein the ID verification device further includes:
a code length determination circuit connected to the code generation circuit and the first ID generation circuit for determining the code length of the random code string, wherein the code length determination circuit provides the first and second ID generation circuits with the random code string having the determined code length.

13. The system according to claim 7, wherein the ID verification device includes:
a clock signal generation circuit for generating a clock signal and providing the clock signal to the accessory;
a clock signal output terminal connected to the clock signal generation circuit, wherein the clock signal output terminal is used to output the clock signal;
a first buffer connected to the clock signal output terminal for receiving a sensing signal, which indicates the state of the accessory, from the accessory via the clock signal output terminal; and
a tri-state buffer connected to the clock signal output terminal for providing the ID generation device with the clock signal in accordance with a predetermined control signal;
wherein the ID generation device includes:
a clock input terminal used to receive the clock signal and output the sensing signal; and
a second buffer connected to the clock input terminal for buffering the clock signal.

14. The system according to claim 13, wherein the ID verification device further includes an input/output circuit connected to the code generation circuit and the comparison circuit for providing the second ID generation circuit with the random code string, wherein the input/output circuit receives the second ID code from the second ID generation circuit and provides the comparison circuit with the second ID code, the input/output circuit having the first buffer and the tri-state buffer.

15. The system according to claim 14, wherein the predetermined sensing signal indicates temperature information of the accessory.

16. The system according to claim 7, wherein the ID verification device includes:
a first input/output terminal connected to the code generation circuit, wherein the first input/output terminal is used to output the random code string;
a first buffer connected to the first input/output terminal for receiving a sensing signal indicating the state of the accessory from the accessory via the first input/output terminal; and
a tri-state buffer connected to the first input/output terminal for providing the ID generation device with the random code string in accordance with a predetermined control signal;
wherein the ID generation device includes:
a second clock input/output terminal used to receive the random code string and output the sensing signal; and
a second buffer connected to the second input/output terminal for buffering the random code string.

17. The system according to claim 16, wherein the predetermined sensing signal indicates temperature information of the accessory.

18. A method for verifying the validity of an accessory attached to a device body, the method comprising the steps of:
generating a random code string in the device body;
generating a first ID code in the device body by performing a predetermined operation with the random code string;
transferring the random code string to the accessory;
generating a second ID code in the accessory by performing a predetermined operation with the random code string;
transferring the second ID code to the device body;
comparing the first ID code and the second ID code; and
judging whether the accessory is valid in accordance with the comparison result of the comparing step.

19. The method according to claim 18, further comprising the steps of:
adding a header to the random code string;
transferring the random code string to which the header is added to the accessory; and
detecting the header in the accessory, wherein the second ID code transferring step includes transferring the second ID code to the device body subsequent to the detection of the header.

20. The method according to claim 18, wherein the device body generates a clock signal for transferring the random code string to the accessory;
wherein the random code string transferring step includes transferring at least one bit of the random code string to the accessory in a single cycle of the clock signal; and
wherein the second ID code transferring step includes transferring at least one bit of the second ID code during the same cycle as the clock signal of the random code string transferring step.

21. The method according to claim 18, further comprising the step of:
generating a dummy code transferred to the device body prior to the second ID code generating step.
